(19) United States
(12) Patent Application Publication
(10) Pub. No.: US 2010/0028668 A1
(43) Pub. Date: Feb. 4, 2010

(54) STRUCTURAL INSULATED SHEATHING WITH HIGHLY EFFICIENT ADHESIVE

(76) Inventors: Amber L. Janda, Midland, MI (US); Michael E. Rowland, Lake Jackson, TX (US); Dean P. DeWildt, Midland, MI (US)

Correspondence Address: The Dow Chemical Company, Intellectual Property Section, P.O. Box 1967, Midland, MI, 48641-1967, US

(21) Appl. No.: 12/499,451

(22) Filed: Jul. 8, 2009

Related U.S. Application Data
(60) Provisional application No. 61/084,327, filed on Jul. 29, 2008.

(51) Int. Cl. C09J 9/00; C09J 5/00; B32B 7/12

(52) U.S. Cl. 428/342; 156/329; 156/331.7; 428/341

(57) ABSTRACT

Prepare a laminated assembly by providing an insulating member comprising a polymeric foam having opposing surfaces and a structural member by positioning the structural member so as to extend over at least one of the opposing surfaces of the insulating member and providing a moisture-curable hot-melt polyurethane or silicone adhesive having an open time and an application temperature range and disposing the adhesive between the insulating and structural members at a coating weight of 16 grams per square meter or less and three grams per square meter or more while at an application temperature and then pressing the structural and insulating members together during the open time of the adhesive.

### CROSS REFERENCE STATEMENT

This application claims the benefit of U.S. Provisional Application No. 61/084,327, filed Jul. 29, 2008.

### BACKGROUND OF THE INVENTION

1. Field of the Invention

The present invention relates to a laminated assembly comprising at least one insulating member adhered to at least one structural member and a process for producing such a laminated assembly. The laminated assembly has utility as a structural insulated sheathing composition.

2. Description of Related Art

Structural insulated sheathing (SIS) compositions are useful for applying insulation to walls of building structures, particularly outside wall structures. SIS compositions comprise a thermally insulating member (“insulating member”), commonly a polymeric foam, to provide thermal insulation and a structurally reinforcing member (“structural member”) to provide both mechanical integrity to the insulating member and to enhance the mechanical strength of the wall structure containing the SIS composition. A typical use for SIS compositions is as sheathing over a building support structure (for example, wood or metal stud framing). Often, an exterior finishing material such as siding, masonry or stucco is applied over the SIS composition.

SIS compositions offer value over other exterior sheathing components by providing both thermal insulating properties and structurally reinforcing properties in a single product. Other structural sheathing products, such as oriented strand board, plywood, fiberboard and multi-layered pressure-laminated fibrous paperboard offer minimal thermal insulation. Insulating sheathing products such as polymeric foam boards offer thermal insulating properties but lack significant structural mechanical strength. SIS compositions offer benefits of both structural sheathing and insulating sheathing in a single sheathing material.

The value of SIS compositions is ever increasing as the cost of heating and cooling buildings continually increases. Fast and inexpensive methods of manufacturing SIS products is becoming increasingly desirable to cost effectively meet a growing market for SIS compositions. Moreover, ecologically friendly methods of manufacturing SIS products are also desirable including methods that contain minimal volatile organic compounds (VOCs) and that minimize energy requirements during manufacturing. Therefore, SIS manufacturing processes that minimize components, minimize VOC emissions and minimize energy requirements are desirable to provide SIS compositions for an ever increasing market.

### BRIEF SUMMARY OF THE INVENTION

The present invention offers a process for producing a laminated assembly comprising at least one insulating member adhered to at least one structural member and the laminated assembly. The laminated assembly is useful, for example, as a structural insulated sheathing (SIS) composition. The process adheres an insulating member to a structural member with an adhesive at a coating weight of 16 grams per square meter (g/m²) or less. Moreover, the adhesive contains negligible (less than two percent by weight of the total adhesive) VOCs thereby minimizing VOC emissions relative to processes using adhesives with non-negligible VOC content. Still more, the present process uses an adhesive that is neither heat curable nor requiring heat to remove moisture thereby reducing energy consumption and process equipment requirements over processes requiring ovens either to cure an adhesive or to remove moisture or solvent from an adhesive. Such an energy savings can be considerable in the manufacture of laminated assemblies (such as SIS compositions), that inherently incorporate thermally insulating members.

Surprisingly, all of these features are possible by manufacturing the laminated assembly using a particular moisture curable hot-melt adhesive selected from hot-melt polyurethanes and hot-melt silicones.

In a first aspect, the present invention is a laminated assembly comprising: (a) an insulating member comprising a polymeric foam with both the insulating member and polymeric foam having opposing surfaces; (b) a structural member extending over at least one of the opposing surfaces of the insulating member; and (c) a moisture-curable adhesive, selected from a group consisting of hot-melt polyurethanes and hot-melt silicones, located between (a) and (b) at a coating weight of 16 grams per square meter or less and three grams per square meter or more and adhering (a) and (b) together.

In a second aspect, the present invention is a process for preparing a laminated assembly, the process comprising the following steps: (a) providing an insulating member comprising a polymeric foam having opposing surfaces; (b) providing a structural member and positioning the structural member so as to extend over at least one of the opposing surfaces of the insulating member; (c) providing a moisture-curable adhesive having an open time and an application temperature range, the adhesive being selected from a group consisting of hot-melt polyurethanes and hot-melt silicones and before, after or both before and after step (b) and disposing the adhesive between the insulating and structural members at a coating weight of 16 grams per square meter or less and three grams per square meter or more while the adhesive is at an application temperature within its application temperature range; and (d) pressing the structural member and insulating member together during the open time of the adhesive so as to compress the adhesive between the structural and insulating members; wherein the adhesive has a zero shear-rate viscosity of 200,000 centipoise or less at the application temperature and the application temperature is low enough so that the adhesive does not degrade or undergo heat-induced crosslinking in a manner that increases the adhesive's zero shear-rate viscosity above 200,000 centipoise within 24 hours at the application temperature in a moisture- and oxygen-free environment.

The process of the present invention is useful for manufacturing the laminated assembly of the present invention. The laminated assembly of the present invention is useful for insulating and providing structural bracing to walls of building structures.

### DETAILED DESCRIPTION OF THE INVENTION

“ASTM” refers to American Society for Testing and Materials. Use the ASTM test methods herein to characterize components of the present invention and embodiments of the present invention as described below. The test method is either identified further by the year of the test method indicated as a hyphenated suffix to the test number or refers to the most recent test method as of 1 Jul. 2008.

“Facer” refers to a component that extends over and covers an entire surface of another component. For example, a facer over a polymeric foam article extends over and covers an entire surface of the polymeric foam article.

“Layer” refers to a substance extending over a component or between two components. A layer does not necessarily cover an entire surface of a component it extends over. A “continuous” layer covers an entire surface over which it extends. A “discontinuous” layer covers less than an entire surface over which it extends.

“Moisture-curable” means able to chemically cross-link by reacting with moisture.

“Open time” of an adhesive refers to the time window during which components may be brought into contact with an adhesive after application of the adhesive in order to adhere the components together with the adhesive; the useful working time of the adhesive after application. Determine if a given time is within the open time for an adhesive by applying the adhesive at a specific thickness between two substrates to which the adhesive normally adheres, wait the given time and then apply pressure equivalent to 90% of the yield stress, measured in compression, of the insulative panel or the structural panel, whichever is smaller. If the two substrates adhere together, the given time is within the open time of the adhesive. Ideally, the adhesive should have an storage modulus that is 100,000 Pascals or less at the time of bonding the substrates together. Measure storage modulus using Dynamic Mechanical Analysis (DMA).

“Continuous” process refers to a process that takes an initial component through to a product without stopping or being interrupted.

“Automated” processes, once started, proceed without human intervention.

“Thermoplastic” characterizes a polymer that can be repeatedly heated and formed. Thermoplastic polymers are generally linear or slightly branched.

“Thermoset” characterizes a polymer that once formed cannot be reprocessed, that is, cannot be repeatedly heated and formed. Thermoset polymers are generally three-dimensional crosslinked networks of polymer chains.

“Hot Delamination Test” is a test method to evaluate the ability of a laminated assembly such as a SIS composition to remain intact (bonded or adhered together) at elevated temperature. The test method requires placing a planar laminated article that is 0.3 meters wide and 0.6 to 1.2 meters long on end so that the primary surface and the length dimension of each laminated component is perpendicular to the ground and with nothing contacting the primary surface. Sustain the laminated article at 60 degrees Celsius (° C.) for 45 days. The laminate passes the Hot Delamination Test if after the 45 days there is no delamination apparent in the article upon examination with an unaided eye.

“Cold Delamination Test” is a test method to evaluate the ability of a laminated assembly such as a SIS composition comprising polymeric foam to remain intact upon bending at cold temperatures. The test method requires storing a planar laminated article containing a foam member that is 0.3 meters wide and 0.6 to 1.2 meters long in a freezer at −40° C. for six weeks and then, immediately upon removal from the freezer, bending the board around an axis extending along the width dimension and centered on the length dimension until the foam yields and permanently deforms (crimps). The laminate passes the Cold Delamination Test if the foam yields and permanently deforms before the article delaminates sufficiently to be evident to an unaided eye.

The insulating member can comprise or consist of polymeric foam. The polymeric foam is a continuous polymer matrix having cells dispersed therein. The polymer matrix comprises a thermoplastic polymer, a thermoset polymer or a combination of thermoplastic and thermoset polymers. Typically, the polymer matrix is predominately either a thermoplastic polymer or a thermoset polymer. Suitable thermoplastic polymers include alkenyl aromatic polymers and olefinic polymers. Herein, “polymer” includes copolymers and homopolymers. Particularly desirable thermoplastic polymers are alkenyl aromatic polymers, ethylene polymers and propylene polymers. Alkenyl aromatic polymers, particularly styrenic-based polymers including polystyrene homopolymer and styrene-acrylonitrile copolymer are most preferred of the thermoplastic polymers. Suitable thermoset polymers include crosslinked polyurethanes such as polyisocyanurate polymers. The polymeric foam can be any type of foam including extruded foam, molded foam, expanded foam, coalesced bead or strand foam.

The polymeric foam typically includes one or more additive. The polymeric foam can contain additives, typically dispersed within the continuous polymer matrix. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); and acid scavengers (for example, magnesium oxide and tetrasodium pyrophosphate). The polymeric foam can contain glass fibers distributed throughout the foam or as a glass mat within the foam. One desirable foam is polyisocyanurate foam that contains glass fibers dispersed throughout the foam, preferably in the form of an expanded glass mat. The glass fibers are desirable to enhance structural integrity and flame retardance properties.

The polymeric foam can be open or closed celled, but is preferably closed celled to achieve optimal thermal insulating capability. Closed cell foam has less than 30%, preferably 20% or less, more preferably 10% or less and still more preferably 5% or less and most preferably one % or less open cell content. A closed cell foam can have zero % open cell content. Conversely, an open cell foam has 30% or more, preferably 50% or more, still more preferably 70% or more, yet more preferably 90% or more open cell content. An open cell foam can have 95% or more and even 100% open cell content. Determine open cell content using American Society for Testing and Materials (ASTM) method D6226-05.

Desirably, the polymeric foam has a density of 16 kilograms per cubic meter (kg/m³) or more, preferably 24 kg/m³ or more and desirably a density of 64 kg/m³ or less, preferably 48 kg/m³ or less and still more preferably a density of 32 kg/m³ or less. Foams having a density of less than 16 kg/m³ tend to have undesirably low structural integrity. Meanwhile, increasing foam density typically increases the cost of the foam and can increase the thermal conductivity of the foam. Therefore, high densities (greater than 64 kg/m³) and low densities (below 16 kg/m³) are typically undesirable for polymeric foam serving as a thermal insulating member. Determine polymeric foam density using a test method similar to that of ASTM method C-303.

The polymeric foam can have a facer on one or both opposing surfaces of the polymeric foam. The insulating member, as well as the polymeric foam, has opposing surfaces. Desirably, one or both of the opposing surfaces are “primary” surfaces. A primary surface of a component is a surface having a planar surface area equal to the highest planar surface area of any surface of the component. A planar surface area is a surface area as projected onto a plane so as to not take into account protrusions or cavities on a surface topography. A primary surface is typically planar and contains both the width and length dimension of the insulating member or polymeric foam. The length dimension is equal to the largest dimension of an article. The distance between a primary surface and an opposing surface is the thickness of the article.

The opposing surfaces of a polymeric foam can also be the opposing surfaces of the insulating member. Alternatively, if the polymeric foam has a facer on one or more opposing surface the facer or facers may serve as the opposing faces of the insulating member. In one embodiment, the polymeric foam includes a facer comprising an aluminum sheet on one or both of its opposing surfaces, preferably exposed on one or both of its opposing surfaces. The aluminum sheet is a continuous piece of aluminum desirably having a thickness of 20 micrometers (0.9 mils) or more. The facer can be solely an aluminum sheet. Desirably, the aluminum sheet is coated with a wash coat of, for example, a crosslinked polymer over any otherwise exposed surfaces in order to inhibit oxidation of the aluminum. Suitable facers can be multilayer compositions. For example, a trilaminate comprising the following three layers is suitable: aluminum sheet, Kraft paper, metallized polyethylene terephthalate film. In another embodiment, the polymeric foam has a facer comprising a Kraft paper layer, preferably exposed on one or both of its opposing surfaces.

A structural member extends over at least one of the opposing surfaces of the insulating member. The structural member enhances the mechanical integrity of the laminated assembly. For instance, the structural member helps prevent fasteners applied through a laminated assembly from tearing through the laminated assembly. The structural member also serves to transfer external loads from the frame of a building to the structural member by being fastened to the frame, therefore reinforcing the frame of the building. The structural member has opposing surfaces, preferably at least one of which is a primary surface. One of the opposing surfaces becomes affixed to one of the opposing surfaces of the insulating member to form the laminated assembly of the present invention.

The structural member can be, as non-limiting examples, a polymeric composition or a mineral composition. Illustrative mineral compositions include gypsum (see, for example, U.S. Pat. No. 7,255,907 and USP application 20060172110). Illustrative polymeric compositions include synthetic polymer (either thermoplastic or thermoset) and naturally occurring polymers such as cellulose. Desirably, the structural member is or comprises a cellulosic material such as paperboard, cardboard, pressed fiberboard, hardboard, plywood or oriented strandboard.

Desirably, the structural member has a thickness of 25.4 millimeters (one inch) or less, preferably 19 millimeters (0.75 inches) or less, more preferably 12.7 millimeters (0.5 inches) or less, still more preferably 9.5 millimeters (0.375 inches) or less, typically 6.35 millimeters (0.25 inches) or less and can be 3.175 millimeters (0.125 inches) or less and is generally 20 micrometers (0.9 mils) or more thick. Thinner structural members result in lighter weight laminated assemblies that are easier to handle. However, if the structural member becomes too thin it can become ineffective in increasing structural integrity. In one desirable embodiment the structural member is a cellulosic material with a polymer, desirably an olefinic polymer, coating on the surface most proximate to the insulating member or on both opposing surfaces. The olefinic polymer coating is desirable to prevent moisture from penetrating into the cellulosic material.

The structural member also desirably has a weight of 19.5 kilograms per square meter (kg/m²) or less, preferably 15 kg/m² or less, more preferably 10 kg/m² or less, still more preferably 5 kg/m² or less and most preferably 1.44 kg/m² or less and typically is 0.5 kg/m² or more. Determine weight relative to area of a primary surface of the structural member. As the weight of the structural member increases, handling of the laminated assembly becomes difficult so lighter weight structural members are desirable. If the structural member becomes too light, it tends to offer little structural support so weights greater than 0.5 kg/m² are desirable.

A moisture-curable hot-melt adhesive (“adhesive”) resides between the insulating member and the structural member and adheres the two together. To be clear, reference to a “moisture-curable adhesive” generally refers to the adhesive both in its cured state as found in the laminated assembly of the present invention and in its pre-cured state as found in the process aspect of the present invention as well as to the adhesive at any degree of cure from completely uncured to completely cured. “Hot-melt” refers to a characteristic of the adhesive that it reduces in viscosity with heating prior to the onset of irreversible crosslinking (chemical reactions which cause the curing of the adhesive), and does not necessarily imply that the adhesive is crystalline and undergoes a melt phase transition.

The adhesive offers surprising results in both the process and laminated assembly of the present invention. Surprisingly, the adhesive is suitable for disposing as a hot-melt material with sufficient open time to allow manufacture of laminated assemblies while concomitantly providing sufficient adhesive strength at as little as 16 grams per square meter or less, even as little as 11 grams per square meter or less is all that is necessary to prepare a laminated assembly that passes both the Hot and Cold Delamination Tests. Still more, the adhesive does not require a VOC or aqueous carrier solvent so drying or solvent removal is unnecessary in the present process. In particular, the adhesive of the present invention desirably has a VOC concentration of one weight-percent (wt %) or less, preferably 0.5 wt % or less and can have a VOC concentration of 0.05 wt % or less and even zero wt % based on total adhesive weight. Similarly, the adhesive desirably has a water concentration of one weight-percent (wt %) or less, preferably 0.5 wt % or less, more preferably 0.1 wt % or less based on total adhesive weight.

A suitable moisture-curable hot-melt adhesive has a characteristic application temperature range. The application temperature range is a temperature range over which the adhesive has a limiting viscosity at zero shear-rate (zero shear rate viscosity) of 200,000 centipoise (cps) or less, preferably 100,000 cps or less, more preferably 50,000 cps or less, still more preferably 20,000 cps or less and most preferably 15,000 cps or less and at which the adhesive can exist for 24 hours in an atmosphere free of oxygen and moisture without increasing in viscosity above 200,000 centipoise (cps), preferably 100,000 cps, more preferably 50,000, still more preferably 20,000 cps and most preferably 15,000 cps. Zero shear-rate is used to define the limiting viscosity shear rate. Measure zero-shear rate using oscillatory rheometric techniques. The viscosity of a polymer, at constant temperature, approaches an asymptotic value as the oscillatory shear frequency is decreased to zero. Zero-shear rate viscosity can be determined from many different experimental apparatuses. Measure viscosity using, for example, a Haake type rotational viscometer. A temperature within the application temperature range of an adhesive serves as a suitable application temperature for the adhesive.

The adhesive is moisture-curable, which means that the adhesive undergoes a chemical crosslinking reaction in the presence of moisture. Desirably, ambient moisture is sufficient to cure the adhesive causing further water addition during fabrication to be unnecessary. The adhesive has a useful “open time” that enables use of the adhesive in a continuous and automated laminated assembly production process. Desirably, the adhesive has an open time of 20 seconds or more, preferably 45 seconds or more. The open time is typically 60 minutes or less, preferably 30 minutes or less, still more preferably 15 minutes or less, even more preferably 10 minutes or less, yet more preferably 5 minutes or less.

Desirable adhesives are selected from a group consisting of moisture-curable hot-melt polyurethane compositions and moisture-curable hot-melt silicone compositions. Examples of suitable polyurethane adhesives include MorMelt™ 5006 synthetic adhesive (MorMelt is a trademark of Rohm & Haas Chemicals LLC LTD) and Rakoll™ NP-2075T adhesive (Rakoll is a trademark of H.B. Fuller Licensing & Financing, Inc.). Examples of suitable hot-melt silicone adhesives include those described in published US patent application 2006/0189767A1 and in particular HM-2500, HM-2510, HM-2515 and HM-2520 silicone adhesives from Dow Corning. Moisture-curable hot-melt silicone adhesives are particularly desirable because they tend to provide suitable adhesion at lower coating weights and have longer open times than the hot-melt polyurethane adhesives. Another advantage of the silicone adhesives over the polyurethane adhesives is that the silicone adhesives are more viscoelastic than the urethane adhesives at room temperature and prior to completing crosslinking. As a result, the silicone adhesive tends to remain tacky, even at room temperature, longer than the urethane adhesives. This feature of the silicone adhesives provides for a longer time window in which the substrates can be placed together and still achieve adherence to one another (such a time window is typically called the open time or operating window for the adhesive).

The adhesive desirably provides adhesive strength between the structural member and the insulating member that is sufficiently strong to pass two different adhesive strength tests: Hot Adhesive Strength Test (HAST) and Cold Adhesive Strength Test (CAST). Passing the HAST requires achieving an adhesive strength of 17.5 Newtons per meter (N/m) (0.10 pounds per inch (lb/in)) or more preferably 35.0 N/m (0.20 lb/in) or more. Passing the CAST requires achieving an adhesive strength of 26.3 Newtons per meter (N/m) (0.15 lb/in) or more, preferably 52.5 N/m (0.30 lb/in) or more. Failure in a member refers to permanent, irreversible damage such as tearing or delamination or breakage within that member.

Measure adhesive strength using a laminated assembly test sample that is approximately 4.3 centimeters wide and 25 centimeters long. Remove the polymeric foam portion of the insulating member leaving only its skin or a facer adhered to the structural member. Remove 0.86 centimeters of facer/skin from the structural member along the 25 centimeter length and as measured inwards from the edges of the 4.3 centimeter width so as to leave a 2.54 centimeter wide strip of facer/skin centered on the 4.3 centimeter width and extending the full 25 centimeter length of the sample.

Condition test samples prior to measuring adhesive strength for at least one week at 23° C. and 50% relative humidity. Further condition each test sample depending on which adhesion strength test it is for. For the HAST further condition the test sample for seven days at 60° C. and then test at 60° C. For the CAST further condition the test sample for 24 hours at −29° C. and then test at −29° C.

Measure adhesive strength after conditioning by measuring the force required to peel back a 2.54 centimeter strip of facer/skin at a rate of at least ten data points per second. Use an Instron Universal Materials Testing Device having a 10-200 pound autoranging load cell and Bluehill® or Series IX™ software for data acquisition and machine control (Bluehill is a trademark of Illinois Tool Works Inc. Corporation. Series IX is a trademark of Instron). The test procedure is similar to that of ASTM D3330 Test Method F (Standard Test Method for Peel Adhesion of Pressure-Sensitive Tape).

Laminated assemblies of the present invention desirably pass the Hot Delamination Test, Cold Delamination Test, HAST and CAST.

The Hot Delamination Test is useful to evaluate the structural integrity of a laminated assembly during storage, transportation and installation in a hot environment. It is desirable to avoid delaminating in elevated temperatures that can occur within a truck or warehouse or during storage on a construction site. Laminated assemblies assembled using typical hot-melt adhesives tend to fail the Hot Delamination Test because the adhesive softens and loses adhesive integrity at the elevated temperatures.

The Cold Delamination Test is useful to evaluate the structural integrity of a laminated assembly during storage, transportation and particularly during usage in a cold environment. The adhesive holding members must offer sufficient cold-temperature flexibility so as to avoid delamination of the members when handled at cold temperatures.

Thermosetting adhesives may offer sufficient heat strength to enable a laminated assembly to pass the Hot Delamination Test, but often tend to be so rigid that they fail during the Cold Delamination Test. Thermosetting adhesives may also be so rigid at high temperatures that the difference between the coefficients of thermal expansion (CTE) of the constituent panels (the structural member and the insulating member) may lead to stress concentration points in the adhesive bond as a result of the inability of the adhesive to dissipate these stresses, thereby weakening the bond at these points and initiating delamination during the Hot Delamination Test. Thermosetting adhesives, depending on the crosslink density and the chemical composition of the adhesive, may also soften sufficiently at high temperatures, as a consequence of viscoelasticity, to lower the cohesive or adhesive strength and cause failure of the Hot Delamination Test.

Certain thermoplastic adhesives may offer sufficient heat strength or sufficient flexibility at cold temperatures to enable a laminated assembly to pass the Hot Delamination Test or Cold Delamination Test, respectively, but tend to become brittle at cold temperatures, resulting in failure during the Cold Delamination Test, or may tend to soften and flow at high temperatures, resulting in failure during the Hot Delamination Test.

An ideal adhesive offers sufficient heat resistance to pass the Hot Delamination Test while simultaneously offering sufficient cold flexibility to pass the Cold Delamination Test. Moreover, the ideal adhesive provides sufficient adhesive strength in a laminated assembly to pass the Hot and Cold Adhesive Strength Tests. To achieve such an ideal performance an adhesive must balance multiple competing requirements—including sufficient flexibility to tolerate different expansion rates of adherends yet not so much flexibility that it becomes soft at elevated temperature and allows delamination of adherends. Surprisingly, the adhesives of the present invention qualify as such an ideal adhesive.

Performance characteristics of an adhesive that make it desirable as an adhesive for use in the present invention include those in Table 1. The characteristics are of the adhesive in its performance state (that is, as it is in a laminated assembly; for example, in its cured state if it is a curable adhesive) as opposed to its pre-deposition state. Even more desirable is an adhesive that is approximately or actually 100% solids prior to deposition and that meets the desirable characteristics of Table 1. Properties are for the crosslinked polymer formed by curing a moisture curable adhesive in a laminated assembly unless otherwise noted. Desirable adhesives can have any combination of preferred, more preferred and most preferred values for the different properties (for example, one desirable adhesive may have preferred percent elongation and a more preferred storage modulus).

TABLE 1

| Property | Test method(s) | Preferred | More preferred | Most preferred |
|---|---|---|---|---|
| Percent elongation | ASTM D412 | >300% | >500% | >700% |
| | (73° F. and 50% RH) | | | |
| Tensile modulus | ASTM D412 | >0.5 MPa | >2 MPa | >3 MPa |
| at 100% | (73° F. and 50% RH) | | | |
| elongation | | | | |
| Storage modulus^{b} | Dynamic Mechanical | <1000 MPa | <750 MPa and | <500 MPa and |
| | Analysis (DMA)^{a} | and >0.05 MPa | >0.1 MPa | >0.5 MPa |
| Viscous modulus^{b} | Dynamic Mechanical | <100 MPa | <75 MPa | <50 MPa and >0.5 MPa |
| | Analysis (DMA)^{a} | | | |

^{a}Use DMA to further characterize non-polyolefin adhesives. Test conditions: 10 rad/s, 0.5% strain amplitude and a heating rate of 3° C. per minute.
^{b}Storage modulus and viscous modulus values characterize the adhesive over a full temperature range of −40° C. to 70° C. If the storage modulus or viscous modulus is outside of the specified value at any temperature between −40° C. and 70° C. the adhesive is outside the scope of the specified characteristic.

Common classes of adhesives that can exhibit these desirable performance characteristics and that are approximately or actually 100% solids include low to medium-modulus thermosetting or crosslinking adhesives (for example, one-component polyurethane and silicone moisture-cure adhesives), and pressure-sensitive adhesives (PSAs) with base polymers of, for example, natural rubber, poly[styrene-b-(ethylene-co-butylene)-b-styrene] (SEBS), styrene isoprene styrene (SIS) block copolymers, acrylates, latexes, butyl, polyisobutylene, and styrene butadiene copolymers including butyl, neoprene, and polysulfide rubbers. The thermosetting or crosslinking adhesives, most preferably the polyurethane and silicone moisture curable adhesives, are most desirable because they more readily provide the desirable performance characteristics at the adhesive coating weight ranges of the present invention than thermoplastic PSA type adhesives.

A low storage modulus and high percent elongation are desirable in an adhesive for the present invention in order to adhere materials that change dimensions in an unequal fashion (for example, materials with different coefficients of thermal expansion or with different rates of moisture absorption and/or release). If the storage modulus is too high, the adhesive will not be able to pass each of the Hot Delamination Test, Cold Delamination Test and Adhesive Strength Tests. However, if the storage (or viscous) modulus at use temperature is too low, the cohesive strength of the adhesive will be insufficient, leading to failure of the adhesive bond within the adhesive layer itself. Storage modulus increases in thermoset compositions with the extent of crosslinking. Therefore, heavily crosslinked adhesives tend to be undesirable. In thermoplastic polymers, storage modulus increases as polymer temperature decreases and experiences a dramatic change at the polymer's glass transition temperature (Tg). Storage modulus can increase by over an order of magnitude upon crossing from above to below a polymer's Tg, resulting in a corresponding decrease in flexibility and ability to deform in response to an applied load. Thus, Tg is of critical importance, especially where the rates of physical dimensional changes of the constituent panels in the composite differ substantially. Many adhesive compositions containing long blocks of different compositions derived from different monomers (for example, block copolymers), especially pressure-sensitive and unsaturated elastomeric polymers, contain multiple glass transitions because the different blocks tend to form separated phases. For example, a semicrystalline phase can become dispersed within an amorphous matrix to provide a composition having an amorphous phase Tg and a semicrystalline phase Tg. Desirably, the thermoplastic polymeric adhesive a Tg that is 10° C. or more, preferably 20° C. or more, below the lowest anticipated service temperature of the laminated assembly.

The adhesive is present between the insulating member and the structural member at a coating weight of 16 grams per square meter (g/m²) or less. A surprising advantage of the adhesives of the present invention is that they are particularly efficient, meaning at surprisingly low coating weights they still enable a laminated assembly to pass the Delamination and Adhesive Strength Tests. Desirably, the adhesive is present at a coating weight of 16 g/m² or less, preferably 12 g/m² or less, more preferably 11 g/m² or less, still more preferably 10 g/m² or less, even more preferably 9 g/m² or less and can be 5 g/m² or less. In some instances the silicone adhesives tend to be more efficient than the polyurethane adhesives, meaning less silicone adhesive is needed to achieve similar adhesive strength. When using adhesive coating weights below 10 g/m², and especially below 9 g/m² it is generally most desirable to use a silicone hot-melt moisture-curable adhesive. Adhesive is desirably present at a coating weight of three g/m² or more to ensure adequate adhesion between the structural and insulating members.

Coating weight of adhesive is the mass of adhesive relative to the area of structural member adhered to an insulating member. The adhesive can be present as a continuous layer between the insulating and structural members or may be a discontinuous layer.

The polyurethane and silicone adhesives of this invention would be particularly effective at adhering surfaces having chemically active hydrogens that react with functionalities such as isocyanates. Such a surface facilitates chemical bonding between molecules in the surface with molecules in the polyurethane and silicone adhesive. A surface containing active hydrogen compounds would constitute a surface having active hydrogens. In general, a compound having active hydrogens displays significant activity according to the Zerewitinoff test described by Woller in the Journal of The American Chemical Society, Vol. 49, page 3181 (1927). Specifically included within the definition of active hydrogen compounds are alcohols, amines, amides, mercaptans and acids.

The process for preparing the laminated assemblies of the present invention comprises: (a) providing an insulating member as described above, (b) providing a structural member as described above and positioning the structural member so as to extend over at least one of the opposing surfaces of the insulating member, (c) providing a moisture-curable hot-melt adhesive (as described above) at its application temperature before, during, after or any combination of before, during and after step (b) and disposing the adhesive between the insulating and structural members at a coating weight of 16 g/m² or less and 3 g/m² or more while the adhesive is at an application temperature within its application temperature range, and (d) pressing the structural and insulating members together in the adhesive's open time to compress adhesive between the structural and insulating members.

Disposition of the adhesive in step (c) can involve providing the adhesive as a continuous or discontinuous layer on a surface of one or both of the insulating and structural members. Dispose adhesive in any number of ways including brushing, wiping, doctoring with a blade and spraying. In a preferred embodiment, dispose adhesive in fibrous form onto a surface of one or both of the insulating and structural members. Dispose adhesive in fibrous form in any conceivable pattern including straight lines, curved lines, swirled lines or any combination thereof. In order to obtain optimal adhesive strength between the insulating and structural members the adhesive in fibrous form desirably has a diameter of 0.05 millimeters or more, preferably 0.1 millimeters or more and still more preferably 0.2 millimeters or more. The adhesive in fibrous form desirably has a diameter that is less than one millimeter and preferably less than 0.6 millimeters. If the diameter is greater than one millimeter, too little surface area tends to be covered at the desired coating weight. If the diameter is too small, the adhesive thickness becomes too little to adequately adhere the components together. Desirably, the adhesive resides, with respect to mating surfaces of an insulating member and a structural member, around the perimeter of the insulating member surface, the structural member surface or both to decrease likelihood of edges to delaminate.

If the adhesive is disposed in a discontinuous layer (for example, in a fibrous form with spaces of surface having an absence of adhesive) it is desirable that any portion of surface on which adhesive is disposed, but that is free of adhesive, is within 15 centimeters, preferably 10 centimeters, more preferably 5 centimeters, still more preferably 1 centimeter, even more preferably 5 millimeters, yet more preferably 2 millimeters and most preferably 1 millimeter of adhesive. For example, in one embodiment it is generally desirable to dispose fibers in lines that have a spacing from one another of 3.2 millimeters or less.

It is conceivable to apply adhesive to mating surfaces of both the insulating and structural members—mating surfaces being the surface of the insulating member and the surface of the structural member that adhere to one another. It is acceptable and typically easier to apply adhesive to only one of the two mating surfaces. Dispose the adhesive at a coating weight consistent with that for the laminated assembly described above.

The adhesive desirably has a VOC concentration of one weight-percent (wt %) or less, preferably 0.5 wt % or less and can be 0.05 wt % or less or even zero wt % based on total adhesive weight. The adhesive desirably has a water concentration of one weight-percent (wt %) or less, preferably 0.5 wt % or less, more preferably 0.1 wt % or less based on total adhesive weight. The process of the present invention can be free of VOC devolatization and recovery steps, drying steps, or both VOC devolatization and recovery and drying steps.

It is possible within the scope of the present invention to apply moisture, usually in the form of a mist or spray, to accelerate or promote curing of the adhesive. Typically, application of moisture would occur after deposition of the adhesive and prior to compressing the insulating and structural members together. The process of the present invention does not require and is preferably free of application of moisture.

The process can be discontinuous (that is, a batch process or semi-batch process) or a continuous process. The process is desirably a continuous process, especially one that continuously prepares multiple laminated assemblies, to maximize efficiency. Moreover, the process is desirably automated to further maximize efficiency. Another surprising aspect of the ideal adhesive of the present invention is that it can be applied in fiber or spray form, typically at an elevated temperature. Such an aspect facilitates its use in a continuous laminated assembly production process.

In one desirable embodiment, provide a first substrate selected from the insulating member and structural member. Desirably, though not necessarily, clean a surface of the first substrate by brush, vacuum, wiping, or any combination thereof. Apply the adhesive to the surface of the first substrate, after cleaning if cleaning is to be done. Provide a second substrate that is the other of the insulating member and structural member (that is, the other relative to the first substrate). Align the second substrate over the surface of the first substrate so that the adhesive is between the first and second substrates. “Alignment” can be perfect alignment with respect to the first substrate as well as any of a variety of offset or skewed alignments in which only a portion of the second substrate overlaps the first substrate (that is, a portion of one substrate extends in a dimension further than the other substrate). Feed the first and second substrate through nip rollers to compress the substrates together with the adhesive between them to form a laminated assembly.

In another desirable embodiment, prepare a laminated assembly with more than two substrates adhered to one another in a layered fashion. For example, provide a first substrate selected from the insulating member and structural member. Desirably, though not necessarily, clean a surface of the first substrate by brush, vacuum, wiping, or any combination thereof. Apply the adhesive to the surface of the first substrate, after cleaning if cleaning is to be done. Provide a second substrate that is desirably, though not necessarily, the other of the insulating member and structural member (that is, the other relative to the first substrate). Align the second substrate over the surface of the first substrate so that the adhesive is between the first and second substrates. “Alignment” can be perfect alignment with respect to the first substrate as well as any of a variety of offset or skewed alignments in which only a portion of the second substrate overlaps the first substrate (that is, a portion of one substrate extends in a dimension further than the other substrate). Feed the first and second substrate through nip rollers to compress the substrates together with the adhesive between them to form a laminated pre-assembly. Desirably, though not necessarily, clean an exposed surface of the laminated pre-assembly by brush, vacuum, wiping, or any combination thereof. Apply the adhesive to the exposed surface of the pre-assembly, after cleaning if cleaning is to be done. Provide a third substrate selected from insulating members and structural members. Align the third substrate over the exposed surface of the pre-laminate so that the adhesive is between the third substrate and pre-assembly, with “alignment” having the same meaning as described in the previous paragraph. Feed the pre-assembly/third substrate combination through nip rollers to compress them together with the adhesive between them. Assembly can end there with a three-layer laminated assembly. Alternatively, additional substrates can be adhered onto this three-layer structure in similar fashion as adhering the third substrate onto the laminate pre-assembly to create as many laminated layers as desired and in any order of insulating members and structural members as desired. The final laminated assembly desirably has at least one insulating member layer and one structural member layer.

An advantage of the present process over many alternative processes is that members of the laminated assembly can proceed through the process without having to be heated and thereby require less energy than processes requiring heating. Therefore, a process such as the present one where the laminated assembly can remain at ambient temperature relative to the surrounding process environment is desirable. Heating a laminated assembly during its manufacturing process is common for one or more of the following purposes: to cure an adhesive, to drive off solvents from the composition and to drive off moisture from the composition. The present process may include heating the laminated assembly for any reason, but more importantly, can be free from heating the laminated assembly.

The laminated assembly of the present invention may comprise more than one insulating member, more than one structural member or both more than one insulating member and more than one structural member provided a moisture-curable adhesive selected from hot-melt polyurethane and hot-melt silicones adheres a structural member to an insulating member. For example, a laminated member comprising an insulating member having opposing surfaces with a structural member adhered to one of the opposing surfaces using a moisture-curable adhesive selected from hot-melt polyurethane and hot-melt silicones and either another insulating member or another structural member adhered to the opposing surface falls within the scope of the present invention. Numerous combinations of layered laminated assemblies can be envisioned and fall within the scope of the present invention provided that they comprise a moisture-curable adhesive selected from hot-melt polyurethane and hot-melt silicones adhering a structural member to an insulating member to form the laminated assemblies. Processes for preparing laminated assemblies with more than two members can include adhering members together simultaneously or in any particular order in time. A moisture-curable adhesive, selected from a group consisting of hot-melt polyurethanes and hot-melt silicones can adhere more than two members together in a laminated assembly of the present invention and desirably adheres all members together. A moisture-curable adhesive, selected from a group consisting of hot-melt polyurethanes and hot-melt silicones only need adhere an insulating member to a structural member for the laminated assembly to fall within the scope of the present invention.

TABLE 2

| Adhesive | Description |
|---|---|
| PSA | Thermoplastic non-crosslinking pressure sensitive adhesive (product number |
| | 0195, obtained from Adhesive & Equipment in Highland, MI) |
| PO | Polyolefin based non-crosslinking adhesive (product umber 3254 obtained |
| | from Adhesive & Equipment in Highland, MI on 30 May 2007) |
| Rakoll NP-2075T | Polyurethane resin moisture cure hot melt adhesive available from HB Fuller. |
| (NP-2075T) | |
| MorMelt R-5006 | Polyurethane resin moisture cure hot melt adhesive from Rohm and Haas. |
| (R-5006) | |
| Silicone 1 | A modified formulation of Dow Corning HM-2510 moisture cure hot melt |
| | silicone product that has a zero-shear limiting viscosity of about 15,000 |
| | centipoise at 120° C.. |
| Silicone 2 | A modified formulation of Dow Corning HM-2510 moisture cure hot melt |
| | silicone product that has a zero-shear limiting viscosity of about 11,000 |
| | centipoise at 120° C.. |

Table 2 lists the adhesives used in Examples of the present invention. Tables 3-5 list characteristic properties of those adhesives.

TABLE 3

| | Percent Elongation | Tensile Modulus | | Glass transition |
|---|---|---|---|---|
| Adhesive | (ASTM D412) | (ASTM D412) | | (lowest) |
| PSA | 700% | 0.7 | MPa | −42° C. |
| | | | | (Peak in viscous |
| | | | | modulus) |
| PO | 45% | 0 | MPa^{b} | −5° C. |
| | | | | (Peak in viscous |
| | | | | modulus) |
| NP-2075T | 563% | 49 | MPa | N/A (Crosslinked)^{a} |
| R-5006 | 1220% | 10.5 | MPa | N/A (Crosslinked) |
| Silicone 1 | >1000% | 0.5-0.7 | MPa | N/A (Crosslinked) |
| Silicone 2 | >1000% | 0.5 | MPa | N/A (Crosslinked) |

^{a}N/A is “not applicable”. These materials are sufficiently crosslinked in their performance state that no Tg is apparent between −100° C. and 200° C.
^{b}This sample only elongated to 45% strain before breaking. 20% modulus is 1.7 MPa.

TABLE 4

| | Storage Modulus (MPa) at various temperatures | | | | | | |
|---|---|---|---|---|---|---|---|
| Adhesive | −40° C. | −20° C. | 0° C. | 20° C. | 40° C. | 60° C. | 70° C. |
| PSA | 1125 | 468 | 108 | 22 | 11 | 4 | 1 |
| PO | 1634 | 1361 | 596 | 211 | 52 | 18 | 11 |
| NP-2075T | 828 | 532 | 314 | 188 | 121 | 50 | 29 |
| R-5006 | 778 | 535 | 284 | 217 | 183 | 106 | 104 |
| Silicone 1 | 154-353 | 129-275 | 101-182 | 72-77 | 25-46 | 13-24 | 11-15 |
| Silicone 2 | 353 | 275 | 182 | 77 | 25 | 13 | 11 |

TABLE 5

| Ad- | Viscous Modulus (MPa) at various temperatures | | | | | | |
|---|---|---|---|---|---|---|---|
| hesive | −40° C. | −20° C. | 0° C. | 20° C. | 40° C. | 60° C. | 70° C. |
| PSA | 149 | 127 | 75 | 21 | 4 | 2 | 1 |
| PO | 65 | 100 | 146 | 86 | 26 | 8 | 4 |
| NP- | 57 | 57 | 43 | 27 | 15 | 6 | 3 |
| 2075T | | | | | | | |
| R-5006 | 31 | 56 | 28 | 15 | 9 | 6 | 5 |
| Silicone | 22-47 | 23-51 | 22-57 | 20-48 | 17-20 | 8-13 | 5-11 |
| 1 | | | | | | | |
| Silicone | 47 | 51 | 57 | 48 | 20 | 8 | 5 |
| 2 | | | | | | | |

Characterize adhesive performance of the various adhesive by preparing laminated assembly test samples having a width of 0.3 meters and a length of 0.6 meters. Prepare the laminated assembly test samples by adhering a thermally insulating member (TUFF-R® insulating sheathing, TUFF-R is a trademark of The Dow Chemical Company) to a structural member (red THERMO-PLY™, THERMO-PLY is a trademark of Covalence Specialty Coatings LLC Ltd) using one of the adhesives. Adhere the exposed aluminum facer of the thermally insulating member to the structural member.

Prepare laminated assembly test samples by applying an adhesive to a surface of a structural member at 23° C. and 50% relative humidity using a deposition technique as described for each example. Apply adhesive to the structural member as the structural member passes under applicators on a conveyor. Fifteen seconds after applying the adhesive to the structural member, apply a thermally insulating member over the adhesive and onto the structural member. Feed the combination of members through nip rollers set at a spacing sufficient to compress a distance equal to 99% of the lowest yield strain of either member. Stack the resulting laminated assembly test samples and store at 23° C. and 50% relative humidity for at least one week.

The following examples illustrate embodiments of the present invention.

### EXAMPLE 1

### Adhesive Strength Test Comparisons

Linear Adhesive Beads

Prepare test samples by disposing the adhesive in linear beads at a specified coating weight (see Table 7) using an applicator that contains 12 adjacent 2.54 centimeter dispensing modules extending to a 30.5 centimeter width perpendicular to the direction test samples are moving during manufacture. Each dispensing module contains a zero-cavity nozzle (from Nordson Corporation) having a single orifice through which adhesive flows. The largest dimension of the orifice opening is less than 0.5 millimeter. The distance between the orifice and the surface on which the adhesive is being dispensed is approximately 0.32 centimeters.

Prepare an adhesive for disposition using a melting/heating device (for example, a tank or platen) and then feed the molten adhesive through a hose to the dispensing module and then out through a nozzle onto the structural member. Table 6 lists equipment and environmental conditions for the process.

TABLE 6

| | Adhesive | | | |
|---|---|---|---|---|
| Parameter | PO | PSA | NP-2075T | SILICONE 1 |
| Nozzle Temp. (° C.) | 185 | 185 | 177 | 149 |
| Hose Temp. (° C.) | 177 | 177 | 174 | 135 |
| Melting/Feeding Device Temp. | 177 | 177 | 174 | 135 |
| (° C.) | | | | |
| Ambient Temperature (° C.) | 21 | 21 | 21 | 21 |

Prepare the laminated assembly test samples by adhering a thermally insulating member (TUFF-R® insulating sheathing, TUFF-R is a trademark of The Dow Chemical Company) to a structural member (red THERMO-PLY™, THERMO-PLY is a trademark of Covalence Specialty Coatings LLC Ltd) using one of the adhesives. Adhere the exposed aluminum facer of the thermally insulating member to the structural member. Notably, the aluminum facer in contact with the adhesive has an exposed acrylic washcoat.

The adhesive forms a thin strip of adhesive extrudate in a straight line on the structural member moving under the applicator with each strip centered 2.54 centimeters from an adjacent strip. Adjust the conveyor belt speed and adhesive pump speed to achieve the desired coating weight.

TABLE 7

| | Cold Adhesive | | Hot Adhesive | |
|---|---|---|---|---|
| | Strength Test | | Strength Test | |
| | (CAST) | | (HAST) | |
| | Coating Weight | | Coating Weight | |
| Adhesive | (g/m²) | Pass/Fail | (g/m²) | Pass/Fail |
| NP-2075T | 4.3 | Pass | 4.3 | Fail |
| | 6.5 | Pass | 6.5 | Pass |
| | 8.6 | Pass | 8.6 | Pass |
| | 10.8 | Pass | 10.8 | Pass |
| Silicone 1 | 2.2 | Pass | 2.2 | Pass |
| | 4.3 | Pass | 4.3^{a} | Pass |
| | 6.5 | Pass | 4.3^{a} | Pass |
| | 8.6 | Pass | 6.5^{a} | Pass |
| | | | 6.5^{a} | Pass |
| | | | 8.6^{a} | Pass |
| | | | 8.6^{a} | Pass |
| PO | 6.5 | Fail | 6.5 | Fail |
| | 12.9 | Pass | 12.9 | Fail |
| | 19.4 | Fail | 19.4^{a} | Fail |
| | 23.7 | Fail | 19.4^{a} | Fail |
| | | | 23.7^{a} | Fail |
| | | | 23.7^{a} | Fail |
| PSA | 6.5 | Fail | 6.5 | Pass |
| | 12.9 | Fail | 12.9^{a} | Pass |
| | 19.4 | Fail | 12.9^{a} | Fail |
| | 23.7 | Fail | 19.4 | Pass |
| | | | 23.7^{a} | Pass |
| | | | 23.7^{a} | Fail |

^{a}Two test samples were done for each of these coating weights.

Characterize the test samples according to Hot Adhesive Strength Test and Cold Adhesive Strength Test. Table 7 contains typical test results for various test samples.

The data in Table 7 illustrates that a polyolefin adhesive is inadequate to reliably pass either the HAST or CAST even at coating weights of up to 23.7 g/m². The data in Table 7 also illustrates that the PSA adhesive is inadequate to reliably pass the CAST even at coating weight of up to 23.7 g/m².

In contrast, the polyurethane hot-melt moisture-curable adhesive (NP-2075T) surprisingly passed both the HAST and CAST at a coating weight of 6.5 g/m² and the silicone hot-melt moisture curable adhesive (Silicone 1) passed both the HAST and CAST at a coating weight as low as 2.2 g/m². This comparison illustrates a dramatic advantage of the polyurethane and silicone hot-melt moisture-curable adhesives over PSA and polyolefin adhesives in laminated assembly applications, such as SIS applications. The laminated assembly test samples comprising the NP-2075T adhesive and the Silicone 1 adhesive are examples of laminated assemblies of the present invention.

Narrower Linear Adhesive Beads

Prepare additional test samples in like manner using R-5006 and Silicone 2 adhesives and a closer adhesive bead spacing (and concomitantly smaller adhesive bead diameter for a given adhesive coating weight). Adjust the distance between the orifice and the structural member surface to 3.8 centimeters. Table 8 lists equipment parameters and Table 9 lists CAST and HAST test results, and adhesive coating weights for each sample.

Notably, R-5006 samples could not be prepared at coating weights below 10.8 g/m² because the open time of R-5006 was too short to permit bonding of the structural and insulative members to form a laminated assembly. That is, the R-5006 adhesive hardened before bringing the two members of the assembly together. In contrast, the Silicone 2 adhesive provides suitable assemblies at coating weights well below 10.8 g/m² illustrating the greater versatility of the silicone adhesives. The narrow bead sample results illustrate that the silicone adhesives are typically more efficient at adhering structural and insulative members together than even the polyurethane adhesives.

TABLE 8

Adhesive

| Parameter | R-5006 | SILICONE 2 |
|---|---|---|
| Nozzle Temp. (° C.) | 138 | 132 |
| Hose Temp. (° C.) | 127 | 132 |
| Melting/Feeding Device Temp. (° C.) | 127 | 132 |
| Ambient Temperature (° C.) | 24 | 24 |

TABLE 9

| | Cold Adhesive | | Hot Adhesive | |
|---|---|---|---|---|
| | Strength Test | | Strength Test | |
| | (CAST) | | (HAST) | |
| | Coating Weight | | Coating Weight | |
| Adhesive | (g/m²) | Pass/Fail | (g/m²) | Pass/Fail |
| R-5006 | 15.0^{a} | Pass | 15.0 | Pass |
| | 15.0^{a} | Pass | | |
| Silicone 2 | 7.5^{a} | Pass | 7.5 | Pass |
| | 7.5^{a} | Pass | | |

^{a}Two test samples were done for each of these coating weights.

Narrower Linear Adhesive Beads with Exposed Kraft Paper Facer

Prepare another set of narrower linear adhesive bead test samples except adhere to the Kraft paper surface of a Kraft paper bilaminate aluminum/Kraft paper facer (0.285 mil soft temper aluminum adhered to 30# natural Kraft paper by a water-based adhesive; available from International Convertor, Inc.) on the insulating panel. Kraft paper surface has chemically active hydrogens. Table 10 presents adhesives, coating weights and results for such test samples and illustrates the versatility of the adhesives as effective at low concentration on Kraft paper and adhesion to a surface having chemically active hydrogens.

TABLE 10

| | Cold Adhesive | | Hot Adhesive | |
|---|---|---|---|---|
| | Strength Test | | Strength Test | |
| | (CAST) | | (HAST) | |
| | Coating Weight | | Coating Weight | |
| Adhesive | (g/m²) | Pass/Fail | (g/m²) | Pass/Fail |
| R-5006 | 10.8^{a} | Pass | 10.8 | Pass |
| | 10.8^{a} | Pass | 15.0^{b} | Pass |
| | 15.0^{a} | Pass | 15.0^{b} | Pass |
| | 15.0^{a} | Pass | 15.0^{b} | Fail |
| Silicone 2 | 7.5^{a} | Pass | 7.5^{a} | Pass |
| | 7.5^{a} | Pass | 7.5^{a} | Pass |

^{a}Two test samples were done for each of these coating weights.
^{b}Three test samples were done for each of these coating weights.

The sample results in the previous tables illustrate that polyurethane and silicone moisture-curable adhesives are advantageous over PSA and polyolefin adhesives in laminated assembly applications in regards to adhesive strength. Moreover, the results illustrate that silicone moisture-curable adhesives tend to be more efficient than polyurethane adhesives by providing greater adhesive strength at lower coating weights when using narrow beads of adhesive.

Random Deposition of Adhesive on Metal Facer

Prepare structural members in similar fashion to those for the narrow bead spacing (Table 8 and 9 Samples) except use Uniform Fiber Deposition (UFD) technology by ITW Dynatec Corporation to randomly dispose the adhesive. Replace the nozzles used for the previous test samples with nozzle number 108210 (obtained from ITW Dynatec in February 2008). The nozzles have an orifice spacing of 1.27 centimeters. Dispose the adhesive using the settings in Table 11 and using a system air temperature of 141° C.

TABLE 11

| Adhesive | Coating Weight (g/m²) | Air Pressure (MPa) |
|---|---|---|
| R-5006 | 10.8 | 0.007 |
| | 15.0 | 0.007 |
| Silicone 2 | 7.5 | 0.07 |
| | 10.8 | 0.07 |

Table 12 contains typical results for the samples described in Table 11. The short open time for R-5006 precluded disposing that adhesive at a coating weight below 10.8 g/m².

TABLE 12

| | Cold Adhesive | | Hot Adhesive | |
|---|---|---|---|---|
| | Strength Test | | Strength Test | |
| | (CAST) | | (HAST) | |
| | Coating Weight | | Coating Weight | |
| Adhesive | (g/m²) | Pass/Fail | (g/m²) | Pass/Fail |
| R-5006 | 10.8^{a} | Pass | 10.8^{b} | Pass |
| | 10.8^{a} | Pass | 10.8^{b} | Pass |
| | 10.8^{a} | Pass | 10.8^{b} | Pass |
| | 10.8^{a} | Pass | | |
| Silicone 2 | 7.5^{a} | Pass | 7.5^{a} | Pass |
| | 7.5^{a} | Pass | 7.5^{a} | Fail |
| | 7.5^{a} | Pass | 7.5^{a} | Fail |
| | 7.5^{a} | Pass | 7.5^{a} | Fail |

^{a}Four test samples were done for each of these coating weights.
^{b}Three test samples were done for each of these coating weights.

These samples illustrate the effectiveness of hot-melt polyurethane and hot-melt silicone adhesives in adhering a metal facer to a support member using UFD deposition.

Random Deposition of Adhesive on Kraft Facer

Prepare test samples in like manner as those for Table 12 except adhere the Kraft paper side of a Kraft paper/aluminum bilaminate facer to an insulating panel support member as in the samples of Table 10. Table 13 contains the characterization of samples prepared in this manner. Tables 12 and 13 illustrate the versatility of the adhesives on Kraft paper facers and aluminum facers, and the advantage of the longer open time of the Silicone 2 adhesive. As in Tables 9 and 10, the Silicone 2 can be applied under lower coating weights than R-5006 using the preferred methods of adhesive deposition of the invention, because of the longer open time of Silicone 2.

TABLE 13

| | Cold Adhesive | | Hot Adhesive | |
|---|---|---|---|---|
| | Strength Test | | Strength Test | |
| | (CAST) | | (HAST) | |
| | Coating Weight | | Coating Weight | |
| Adhesive | (g/m²) | Pass/Fail | (g/m²) | Pass/Fail |
| R-5006 | 10.8^{a} | Pass | 10.8^{a} | Pass |
| | 10.8^{a} | Pass | 10.8^{a} | Pass |
| | 10.8^{a} | Pass | 10.8^{a} | Pass |
| | 10.8^{a} | Pass | 10.8^{a} | Pass |
| | 10.8^{a} | Pass | 10.8^{a} | Pass |
| Silicone 2 | 7.5^{b} | Pass | 7.5^{b} | Pass |
| | 7.5^{b} | Pass | 7.5^{b} | Pass |
| | 7.5^{b} | Pass | 7.5^{b} | Pass |
| | 7.5^{b} | Pass | 7.5^{b} | Pass |
| | 7.5^{b} | Pass | 7.5^{b} | Fail |
| | 7.5^{b} | Fail | 7.5^{b} | Fail |
| | 10.8^{a} | Pass | 10.8^{a} | Pass |
| | 10.8^{a} | Pass | 10.8^{a} | Pass |
| | 10.8^{a} | Pass | 10.8^{a} | Pass |
| | 10.8^{a} | Pass | 10.8^{a} | Pass |
| | 10.8^{a} | Pass | 10.8^{a} | Fail |

^{a}Five test samples were done for each of these coating weights.
^{b}Six test samples were done for each of these coating weights.

Prepare another set of test samples in like manner to those in Table 12 except replace the dispensing modules with modules having four orifices per module and a spacing between adjacent orifices of 0.635 cm. Use, for example, UFD (available from ITW Dynatec) or Summit® (available from Nordson Corporation) dispensers. Use the system settings in Table 14 and the temperature settings in Table 5 to dispose the adhesive. Adjust the air pressure to obtain a consistent adhesive pattern, generally 0.01 to 0.10 MPa. Table 15 presents adhesives, coating weights, and results for such test samples.

TABLE 14

| Adhesive | Nozzle | Conveyor speed, m/s | Coat wt., g/m² |
|---|---|---|---|
| PSA | Summit | 0.15 | 6.5 |
| | UFD | * | 6.9 |
| | UFD | * | 10.8 |
| | UFD | * | 16.1 |
| | UFD | * | 21.5 |
| PO | Summit | 0.24 | 6.5 |
| | UFD | * | 6.9 |
| | UFD | * | 10.8 |
| | Summit | 0.10 | 12.9 |
| | UFD | * | 16.1 |
| | Summit | 0.08 | 19.4 |
| NP- | UFD | * | 6.9 |
| 2075T | UFD | * | 10.8 |

* Adjust to achieve specified coating weight and consistent pattern.

TABLE 15

| | Cold Adhesive | | Hot Adhesive | |
|---|---|---|---|---|
| | Strength Test | | Strength Test | |
| | (CAST) | | (HAST) | |
| | Coating Weight | | Coating Weight | |
| Adhesive | (g/m²) | Pass/Fail | (g/m²) | Pass/Fail |
| NP-2075T | 6.9 | Pass | 6.9 | Pass |
| | 10.8 | Pass | 10.8 | Pass |
| A&E PO | 6.5 | Fail | 6.9 | Pass |
| | 6.9 | Fail | 10.8^{a} | Pass |
| | 10.8^{a} | Fail | 10.8^{a} | Fail |
| | 10.8^{a} | Fail | 16.1^{a} | Pass |
| | 12.9 | Fail | 16.1^{a} | Fail |
| | 16.1 | Fail | 19.4 | Fail |
| | 19.4 | Fail | | |
| A&E | 6.5 | Fail | 6.9 | Pass |
| PSA | 6.9 | Fail | 10.8 | Pass |
| | 10.8 | Fail | 16.1 | Pass |
| | 16.1 | Pass | 21.5 | Pass |
| | 21.5 | Pass | | |

^{a}Two test samples were done for each of these coating weights.

As in Table 7, data in Table 15 show that a polyolefin adhesive fails to reliably pass either the HAST or CAST even at coating weights of up to 19.4 g/m². Data in Table 15 show that the PSA adhesive fails to reliably pass the CAST even at coating weights of up to 10.8 g/m².

In contrast, the polyurethane hot-melt moisture-curable adhesive (NP-2075T) 2 surprisingly passed both the HAST and CAST at a coating weight of 10.8 g/m². This comparison illustrates a dramatic advantage of the polyurethane moisture-curable adhesive over PSA and polyolefin adhesives in laminated assembly applications, such as SIS applications. The laminated assembly test samples comprising the NP-2075T adhesive are examples of laminated assemblies of the present invention.

### EXAMPLE 2

### Delamination and Adhesive Strength Testing

The following examples illustrate delamination and adhesive strength for polyurethane and silicone hot-melt moisture-curable adhesives. Prepare test samples in similar fashion to Example 1 except with a slight modification to the dispensing module for the case of the zero-cavity bead modules. Remove the 12 zero-cavity bead dispensers and replace three of them with swirl spray dispensers and the remaining nine with blanks (plugs that prevent flow of adhesive). Position four blank modules between each swirl module so that the total width of the blanks and three active modules is 27.9 centimeters. Position the remaining blank on the end of the applicator width. Adjust the height of the nozzle tips to 21.6 cm above the surface of the substrate onto which adhesive is to be applied. Adjust adhesive pump speed and air pressure to produce a swirl track having a width of 2.50±0.25 centimeters on a structural member passing beneath the applicator. Adjust the conveyor belt speed and pump speed to achieve the desired coating weight. Dispose adhesive using the settings in Tables 5 and 16.

TABLE 16

| Adhesive | Conveyor speed, m/s | Coat wt., g/m² |
|---|---|---|
| NP- | 0.46 | 4.3 |
| 2075T | 0.29 | 6.5 |
| | 0.19 | 8.6 |
| | 0.16 | 10.8 |
| Silicone 1 | 1.35 | 2.2 |
| | 0.78 | 4.3 |
| | 0.65 | 6.5 |
| | 0.63 | 8.6 |

Characterize the resulting test samples according to the Hot Delamination Test, Cold Delamination Test, CAST and HAST. Table 17 presents typical results. The adhesives pass at the adhesive coating weight listed under “Passing Coat Weights” for the deposition technique used in this Example. Notably, the deposition technique used in this Example is expected to provide equal or poorer performance in the tests than, for example, the bead deposition technique used in Example 1 because of the large spacing between adjacent tracks and the resulting low area coverage of adhesive on the surface of the THERMO-PLY structural member.

TABLE 17

| Adhesive | Test | Passing Coat Weights (g/m²)* |
|---|---|---|
| NP-2075T | CAST | 4.3, 6.5, 8.6, 10.8 |
| | HAST | 10.8 |
| | Hot Delamination | 4.3, 6.5, 8.6, 10.8 |
| | Cold Delamination | 4.3, 6.5, 8.6, 10.8 |
| Silicone 1 | CAST | 4.3, 6.5, 8.6 |
| | HAST | 4.3, 6.5, 8.6 |
| | Hot Delamination | 8.6 |
| | Cold Delamination | 4.3 |

*Not all coating weights were tested for all samples. The cold delamination test for the Silicone 1 adhesive was not done at a coating weight above 4.3 once it passed at 4.3. Coating weight information indicates the lowest coating weight that was both tested and that passed the specific test.

Prepare additional test samples in like manner as in Example 1 using Silicone 2 and R-5006 with the Kraft paper and aluminum facers on the insulating member. Characterize the resulting test samples according to the Hot Delamination Test and Cold Delamination Test. Table 18 shows typical results for the case of bead application with a spacing of 0.42 cm and an aluminum facer on the insulating member. The results from the HAST and CAST of Example 1 are also included in the Table. The adhesives pass at the adhesive coating weight listed under “Passing Coat Weights” for the deposition technique used in Example 1.

TABLE 18

| Adhesive | Test | Passing Coat Weights (g/m²) |
|---|---|---|
| R-5006 | CAST | 15.0 (only weight tested) |
| | HAST | 15.0 (only weight tested) |
| | Hot Delamination | 15.0 (only weight tested) |
| | Cold Delamination | 15.0 (only weight tested) |
| Silicone 2 | CAST | 7.5 (only weight tested) |
| | HAST | 7.5 (only weight tested) |
| | Hot Delamination | 7.5 (only weight tested) |
| | Cold Delamination | 7.5 (only weight tested) |

Table 19 presents typical results for bead application with a spacing of 0.42 cm and a Kraft paper facer on the insulating member. Table 20 presents typical results for Uniform Fiber Deposition (UFD) and an aluminum facer on the insulating member. Table 21 presents typical results for UFD and a Kraft paper facer on the insulating member.

TABLE 19

| Adhesive | Test | Passing Coat Weights (g/m²) |
|---|---|---|
| R-5006 | CAST | 10.8, 15.0 |
| | HAST | 10.8, 15.0^{a} |
| | Hot Delamination | 15.0 (only weight tested) |
| | Cold Delamination | 15.0 (only weight tested) |
| Silicone 2 | CAST | 7.5 (only weight tested) |
| | HAST | 7.5 (only weight tested) |
| | Hot Delamination | 7.5 (only weight tested) |
| | Cold Delamination | 7.5^{b} (only weight tested) |

^{a}2 samples out of 3 passed at this weight
^{b}1 sample out of 2 passed at this weight

TABLE 20

| Adhesive | Test | Passing Coat Weights (g/m²)* |
|---|---|---|
| R-5006 | CAST | 10.8 (only weight tested) |
| | HAST | 10.8 (only weight tested) |
| | Hot Delamination | 10.8 (only weight tested) |
| | Cold Delamination | 10.8 (only weight tested) |
| Silicone 2 | CAST | 7.5 (only weight tested) |
| | HAST | 7.5^{a} (only weight tested) |
| | Hot Delamination | Not tested |
| | Cold Delamination | Not tested |

^{a}1 sample out of 4 passed at this weight

TABLE 21

| Adhesive | Test | Passing Coat Weights (g/m²) |
|---|---|---|
| R-5006 | CAST | 10.8^{a} (only weight tested) |
| | HAST | 10.8 (only weight tested) |
| | Hot Delamination | 10.8 (only weight tested) |
| | Cold Delamination | 10.8 (only weight tested) |
| Silicone 2 | CAST | 7.5^{b}, 10.8 |
| | HAST | 7.5^{c}, 10.8^{c} |
| | Hot Delamination | 7.5^{d}, 10.8 |
| | Cold Delamination | 10.8 |

^{a}2 of 5 samples passed
^{b}5 of 6 samples passed
^{c}4 of 6 samples passed
^{d}1 of 2 sample passed

The Example 2 test samples illustrate an unexpectedly efficient performance of the polyurethane and silicone adhesives in that even at coating weights of 10.8 g/m², the adhesives enable the test samples to pass all four of the performance tests. Other polyurethane and silicone hot-melt moisture-curable adhesives having similar properties are expected to perform with similar efficiency.

### EXAMPLE 3

### Continuous Automated Process/Laminated Assembly

One desirable embodiment of the process of the present invention is a continuous automated process. This example provides one embodiment within the scope of a continuous automated process.

Provide a stack of 0.125-inch (3.18 millimeter) thick sheets of Thermo-Ply™ protective sheeting (Thermo-Ply is a trademark of Covalence Specialty Coatings LLC Ltd) that are 48 inches (1.22 meters) wide and 96 inches (2.44 meters) long on a hydraulic lift table. The hydraulic lift table maintains the top of the stack of Thermo-Ply sheets at a constant height, adjusting as a sheet of Thermo-Ply is removed. Provide automated vacuum suction cup lift system that travels on a rail system and repeatedly carries the top sheet of Thermo-Ply from the stack into a set of rubber pinch rollers, releases the sheet of Thermo-Ply and then returns to pick up the new top sheet of Thermo-Ply.

The rubber pinch rollers have an adjustable speed that dictates the line speed for the process. The pinch rollers push the Thermo-Ply into a brush roll unit that uses a rotating soft bristle brush to remove surface contaminates from the Thermo-Ply. A second set of pinch rollers transfer the Thermo-Ply from the brush roller to an adhesive applicator. The adhesive applicator has a 48 inch (1.22 meters) wide die with 48 one-inch wide nozzles. Each nozzle has an orifice for injecting a hot melt adhesive and an orifice for a stream of air. The orifice for the stream of air has adjustments enabling turning on, turning off and varying the extent of air streaming out. The air stream can be used to direct a stream of hot melt adhesive into patterns. Deliver a suitable hot melt adhesive as described previously from a heated platen hot melt system from drums and meter by a gear pump. Dispose fibers of hot melt adhesive onto the sheet of Thermo-Ply in a specific pattern in accordance with teachings in this application. Transfer the Thermo-Ply by powered conveyor to a positioning station that repeatedly and precisely positions Thermo-Ply in the same place using retractable stops.

Provide a stack of polyisocyanurate foam sheet (for example, SUPER TUFF-R™ insulation, SUPER TUFF-R is a trademark of The Dow Chemical Company) that is 48 inches (1.22 meters) wide and 96 inches (2.44 meters) long on a lifting unit that maintains the height of the top foam sheet at a constant height, adjusting as sheets are removed. Provide automated vacuum suction cup lift system that repeatedly carries the top foam sheet from the stack, places the foam sheet into an alignment station, releases the foam sheet and then returns to pick up the new top foam sheet.

A set of continuously turning canted rollers drive the sheet of foam into a fixed corner to ensure precise location of the foam. Pick up the precisely positioned foam sheet using automated suction cups and dispose it onto the Thermo-Ply that has been treated with hot melt adhesive such that the adhesive is between the foam sheet and Thermo-Ply. Compress the foam sheet against the Thermo-Ply and then release the suction cups. Deposition of adhesive onto the Thermo-Ply, disposition of the foam sheet onto the Thermo-Ply and compression against the Thermo-Ply all occur within the open-time of the hot melt adhesive.

Then retract the stops used to align the Thermo-Ply and the powered conveyor transports the composition into two eight-inch (5.08 centimeter) diameter nip rubber nip rollers that compress the foam sheet and Thermo-Ply together. The composition continues through the nip roller and onto a conveyor to an automated stacking unit. The stacking unit includes a tamper for two sides to ensure a properly aligned stack of product results. The stacking unit stacks the compositions (product).

The process may further comprise a step that transfers a stack of product to a hooding location where a five-sided plastic bag is placed over the stack of product.

The process operates automatically and continuously to prepare laminated assemblies from a stack of Thermo-Ply and a stack of foam sheet. While this example identifies polyisocyanurate foam, the process works equally well with a thermoplastic foam sheet. Similarly, while the process identifies Thermo-ply sheets as structural members, the process works equally as well with other structural members.

What is claimed is:

1. A process for preparing a laminated assembly, the process comprising the following steps:
(a) providing an insulating member comprising a polymeric foam having opposing surfaces;
(b) providing a structural member and positioning the structural member so as to extend over at least one of the opposing surfaces of the insulating member;
(c) providing a moisture-curable adhesive having an open time and an application temperature range, the adhesive being selected from a group consisting of hot-melt polyurethanes and hot-melt silicones and before, after or both before and after step (b) and disposing the adhesive between the insulating and structural members at a coating weight of 16 grams per square meter or less and three grams per square meter or more while the adhesive is at an application temperature within its application temperature range; and
(d) pressing the structural member and insulating member together during the open time of the adhesive so as to compress the adhesive between the structural and insulating members;
wherein the adhesive has a zero shear-rate viscosity of 200,000 centipoise or less at the application temperature and the application temperature is low enough so that the adhesive does not degrade in a manner that increases adhesive's zero shear-rate viscosity above 200,000 centipoise within 24 hours at the application temperature in a moisture-free and oxygen-free environment.

2. The process of claim 1 wherein the crosslinked polymer has a percent elongation according to ASTM method D412 of greater than 300%; a tensile modulus at 100% elongation according to ASTM D412 of less than 15 megapascals; a storage modulus according to ASTM D4065 of less than 0.2 megapascals; a viscous modulus according to ASTM D4065 of less than 0.2 megapascals

3. The process of claim 1, wherein any portion of insulating or structural member surface on which adhesive is disposed but that does not contain adhesive is within 0.16 millimeters of adhesive.

4. The process of claim 1, wherein the coating weight of adhesive is ten grams per square meter or less and 3 grams per square meter or more.

5. The process of claim 1, wherein the adhesive is a moisture-curable hot-melt silicone and the coating weight of adhesive is less than nine grams per square meter and 3 grams per square meter or more.

6. The process of claim 1, wherein the process is free of a drying step and a devolatization step.

7. The process of claim 1, characterized as a process that repeatedly cycles through steps (a) through (d) in a continuous and automated manner so as to produce multiple laminated assemblies without human intervention.

8. The process of claim 10, further characterized by providing a first substrate selected from the insulating member and structural member, cleaning a surface of the first substrate by brush, vacuum, wipe or any combination thereof, applying the adhesive to the surface of the first substrate, providing a second substrate that is the other of the insulating member and structural member and aligning the second substrate over the surface of the first substrate so that the adhesive is between the first and second substrates, feeding the first and second substrates through nip rollers to compress the substrates together with the adhesive between them to form a laminated assembly.

9. A laminated assembly comprising:
(a) an insulating member comprising a polymeric foam with both the insulating member and polymeric foam having opposing surfaces;
(b) a structural member extending over at least one of the opposing surfaces of the insulating member; and
(c) a moisture-curable adhesive, selected from a group consisting of hot-melt polyurethanes and hot-melt silicones, located between (a) and (b) at a coating weight of 16 grams per square meter or less and three grams per square meter or more and adhering (a) and (b) together.

10. The laminated assembly of claim 12, wherein the moisture-curable adhesive has a percent elongation according to ASTM method D412 of greater than 300%; a tensile modulus at 100% elongation according to ASTM D412 of less than 15 megapascals; a storage modulus according to ASTM D4065 of less than 0.2 megapascals; a viscous modulus according to ASTM D4065 of less than 0.2 megapascals.

11. The laminated assembly of claim 12, wherein the laminated assembly passes both Hot and Cold Adhesive Strength Tests.

12. The laminated assembly of claim 12, wherein the adhesive is at a coating weight of ten grams per square meter or less and the laminated assembly further passes both the Hot and Cold Delamination Tests.

13. The laminated assembly of claim 12, wherein the adhesive is a hot-melt silicone at a coating weight of less than nine grams per square meter.

14. The laminated assembly of claim 12, wherein any portion of insulating or structural member surface on which adhesive is disposed but that does not contain adhesive is within one millimeter of adhesive.

15. The laminated assembly of claim 12, wherein the structural member comprises a cellulosic material.

16. The laminated assembly of claim 12, wherein the structural member comprises a cellulosic material having opposing surfaces and a polyolefin coating on at least one of those opposing surfaces that is in contact with the adhesive.
